(19) United States
(12) Patent Application Publication
(10) Pub. No.: US 2003/0135384 A1
(43) Pub. Date: Jul. 17, 2003

(54) Workflow process method and system for iterative and dynamic command generation and dynamic task execution sequencing including external command generator and dynamic task execution sequencer

(76) Inventor: Huy Nguyen, Sunnyvale, CA (US)

Correspondence Address: HUY NGUYEN, 252 CORRAL AVENUE, SUNNYVALE, CA, 94086, US

(21) Appl. No.: 10/233,738

(22) Filed: Sep. 3, 2002

Related U.S. Application Data
(60) Provisional application No. 60/324,933, filed on Sep. 27, 2001.

(51) Int. Cl. G06F 17/60

(52) U.S. Cl. 705/1

(57) ABSTRACT

A computer-implemented task workflow management system is provided in which the workflow engines, the program execution means, the process execution rule and the business flow rules are external to the rule evaluator. The invention relates generally to task workflow management systems. More particularly, the present invention relates to a workflow management system which can generate dynamically and iteratively program commands to execute external tools and workflow systems, and can vary task execution sequences dynamically by applying rules to generate next goal or next activity at run time. Business process solutions can be updated automatically and dynamically in response to changes, additions or deletions in any one environment, applications program, and/or change to business data as results of prior implementation of the business solutions. The execution sequences can be dynamically and iteratively updated in response to changes as a result of prior implementation of the business solutions.

### CROSS-REFERENCE TO RELATED APPLICATION

This application claims the benefit of prior U.S. Provisional Application Serial No. 60/324,933, filed Sep. 27, 2001, which is hereby incorporated by reference.

### STATEMENT REGARDING FEDERALLY SPONSORED RESEARCH OR DEVELOPMENT

Not Applicable.

### FIELD OF THE INVENTION

The invention relates generally to workflow process management systems. More particularly, the present invention relates to a dynamic workflow process management system which can generate dynamically and iteratively program commands to execute external tools and workflow systems, and can vary task execution sequences dynamically by applying rules to generate next goal or next activity at run time. Business process solutions can be updated iteratively and dynamically in response to changes, additions or deletions in any one environment, applications program, and/or change to business data as results of prior implementation of the business solutions. The execution sequences can be dynamically and iteratively updated in response to changes as a result of prior implementation of the business solutions.

### BACKGROUND ART

Today, numerous software tools, products and systems exist. Spreadsheets, word processors, database systems are examples of tools that can be used to boost business productivity. Groupware programs, such as electronic mail systems and workflow systems allow collaboration with a larger group to boost productivity and increase multi-user communication.

The use of software tools has led to a tremendous increase in the amount of information and data generated. This increase in information, in turn, spurred the development of various groupware products to automate the process of collecting information and to provide features and utilities in assisting people working together. Groupware products which seek to automate information processing by routing items and managing workflow based on rules set up by users are transaction-based groupware, i.e., it is activated automatically based on the transactions. A workflow management system is an example of a transaction-based groupware.

Workflow management systems (or workflow engines) (WFMs) are designed to handle system processing automatically by routing items and managing workflow based on rules set up by users. The WFMs are particularly suited as an information processing system where electronic documents and functions are passed from one processing step to the next.

The WFMs are generally defined and configured to accommodate a user defined workflow. A designer first defines a workflow by providing the system with a template of business activities that expresses the manner in which these activities relate to one another. Where the system must integrate various types of application software, partition tasks among various operators, computers and computer terminals, the designer must first specify the various components and all manners in which these activities relate to one another. Where workflow systems are designed to operate across a number of platforms and environments, systems use an integrator or broker or similar means of collecting the various component together into one functional unit designed to meet the specific requirements of one user (normally the business solutions owner). Once the system is set up, it may be relatively easy to change the parameters of the solution set, but it requires redesign and recoding of the links to change the underlying process or the order of the logic flow or task execution sequencing.

Many systems and implementations developed before, after or concurrent with the WFMs are deployed or connected with the WFMs to provide additional functionalities or to assist in the design, documentation, execution, control and optimization of business work flow. For example, a number of application servers (AS) exist to provide infrastructure and services that make it possible to serve applications using Internet-related technologies and improve the communication and execution of external system as well as with other e-business applications. Other systems, such as the Microsoft Transaction Services (MTS), Advanced Microsoft Component Object Model (COM+) or .NET technology, provide similar functionalities but are not necessarily characterized as application servers.

The recent proliferation of Extended Markup Language (XML) standard has transformed the creation and exchange of information, not only through the Internet but also where such information needs to be captured and used in the WFMs. Applying the XML technology, information can be described as structured documents. Document element can be parsed, document structure can be evaluated, and document data element can be read or filled with data.

A number of data base management system (DBMS) platforms exist, including, for representative purposes, system platforms developed and commercialized by Oracle Corporation, Microsoft Corporation and others.

A number of commercial application-specific software systems exist, including, for representative purposes, Enterprise Resource Planning (ERP) systems, Customer Relationship Management (CRM) systems and other applications. Within the ERP or CRM applications, WFM systems are typically used to manage the routing, queuing, and tracking of work or customized tasks or task provided by the commercial applications.

Currently, many WFM systems exist. Many WFM systems are based on a client/server architecture. Typically, WFM systems may define computer-based work steps or tasks, workflow data management, or optimize enterprise application integration with the users' workflows and the user interface, but these parts of the WFM system also may be left to system integrators to develop.

It will be appreciated by one skilled in the art that there are significant limitations to the current method of designing, implementing and updating the workflow engines, including:

System Update to Accommodate Changes to Platforms, Environment and Tools—While workflow engines can be designed by the human operator to combine disparate platforms or tools, existing workflow engines must be redesigned and recoded to update changes to the business solutions and to deploy the updates across the solution set. Systems cannot be updated dynamically on the fly and with minimal disturbances to the process.

Use by Multiple Set of Users with Shared Process—A shortcoming of the current technology is the inability of existing technology to be applied in a Web hosting environment where one provider must provide cost-effective and customized solutions to a number of clients, each with their own business solution sets. There is no standard multi-company solution, and there is no standard solution where different users have different needs while sharing process across many environments. In particular, this has impeded the development of efficient application service providers (ASPs) who are in the business of providing the same or very similar business solution sets for users with very different business logics.

Static Flow—Workflow engines are designed to flow the performance of tasks so that they occur in the specified order. Workflow engines cannot easily accommodate the user's needs where the task flow is desired to be dynamic to reflect changing conditions or to reflect the results of the last action or last set of actions.

Preservation of Business Solution Set Integrity. Workflow engines are designed to address the business solution needs of one specific user. Where different subsets of users require related but different business solutions, the core workflow engines are redesigned to be a distinct workflow engine with the same set of core features to accommodate a specific subset of users. Related workflow engines are created to accommodate different subsets of users. A change to the core set of business solutions require a redesign and updating throughout all the branching of the workflow engines. Significant resources are required to track the branches, properly update and maintain the different versions and preserve the integrity of the core business solution set throughout the enterprise.

Interruption to System for Updates—A shortcoming of the current technology is that tools, e.g., applications and software programs, need to be identified and linked to a specific workflow engine or workflow management process in order for these applications to access and share information with one another when working together in a single implementation to carry out a business solution. If the business needs change for any one particular recipient, workflow access and implementation must be interrupted for all recipients while the workflow engine is updated to reflect the business needs.

Large Program Overhead—A further shortcoming of the present system is the weight and overhead of the workflow engine or workflow management process because each data points, rules, sequences, process and execution commands all need to be identified and linked in a predetermined manner into the specific workflow engine or workflow management process

Scalability/Extensibility—Another shortcoming of the present system is the inability to add a data source, an application or to make changes in inputs, processes or outputs without stopping the workflow and making adjustment to the workflow engine by recoding.

### SUMMARY OF THE INVENTION

The present invention is a new paradigm in the design and linkage of tasks in a workflow management system to generate dynamically and iteratively program commands to execute external tools and workflow systems, and to vary task execution sequences dynamically by applying rules to generate next goal or next activity at run time. The present invention provides a new approach to the design of large application systems by representing workflow tasks, herein referred to as an activity node, and their relationship to other activity nodes in a fully modular and dynamic fashion. That is, a dynamic activity node is a discrete, self-contained package containing the following seven attributes: identification means for the activity node, identification means for the data source(s) linked to the activity node, identification means for the data target(s) linked to the activity node, a business execution rule to generate program instruction commands necessary for the completion of the activities, a default value command string for business execution, a business flow rule to generate means to return data to the rule evaluator for identification of the next activity to be executed, and a default next activity for business flow. The dynamic activity node is described and captured in a structured format of the users' choice, as an ASCII file, such as XML, or in a database format. One or more attributes of a given activity node can be set to empty or null.

The workflow engine, the rule evaluator and the program execution means are external to the dynamic activity node, such that the activity nodes are decoupled from the rule evaluator and from each other.

The business solution is captured as a collection of dynamic activity nodes having dynamic links to the data sources, the data targets and the execution means through program means diagrammed as a process map in FIG. 1.

The order and relationships among the dynamic activity nodes are altered automatically through the operation of the business flow rules. Consequently, the workflow can dynamically harmonize among the activity nodes and self-update iteratively to conform to the requirements of the business solution as new data, processes and other components of the activity nodes may require.

An object of the present invention is to provide a modular method and system to separate the components of the business solution set into dynamic activity nodes, dynamically linked together through the operation of the business execution rule and business flow rules.

Another object of the present invention is to provide a modular method and system to separate the process execution and the rule engine. This separation provides the flexibility required to adapt new changes to the process execution and to integrate new processes

Another object of the present invention is to provide a method and system that allows a user to develop text-based business process solutions without compiling or linking using heterogeneous tools, applications, environments and workflow systems.

A further object of the present invention is to provide a method and system that allows maximum reusability of discrete elements within a business solution set to iteratively update such business solution set or to deploy in other business solution sets.

Still another object of the present invention is to provide a method and system that allows for the deployment of business process solutions ideally suited for a web hosting environment or a web exchange environment or for the use of an application service provider providing services to multiple users with similar business solution sets but very different business logics, data sources and targets

A further object of the present invention is to provide a method and system that allows the results of the business process solution to update and populate throughout the system and to be re-captured by the workflow management system on the fly.

Yet another object of using the present invention is that the users can have functionalities and features similar to those currently provided by the workflow engines and existing technology in a lightweight package that overcomes the prior art limitation of weight and overhead.

Still another object of using the present invention is that the users can have functionalities and features similar to those currently provided by the workflow engines and existing technology that can be updated “on the fly” without recoding.

A further object of using the present invention is that the users can have functionalities and features similar to those currently provided by the workflow engines and existing technology but which can be updated without taking the system offline to accommodate changes in data sources, data destination or desired actions.

Yet another object of the present invention is that the users can have functionalities and features similar to those currently provided by the workflow engines and existing technology with minimum coding and recoding, thereby allowing a wider range of users to design and use the present invention, even one who is not necessarily skilled in the art.

Still other objects, features and advantages of the present invention will be readily apparent to those skilled in the art from the following detailed description, wherein a representative embodiment of the invention is shown and described, solely by way of illustration of the best mode contemplated of carrying out the present invention. As will be realized, the present invention is capable of other and different embodiments, and its several details are capable of being modified in various obvious respects, all without departing from the invention. Accordingly, the drawings and description are to be regarded as illustrative in nature, and are not to be restrictive. What is intended to be protected by Letters Patent is as set forth in the appended claims. The present invention will become apparent when taken in conjunction with the following description and attached drawings, wherein like characters indicate like parts, and which drawings form a part of this application.

### BRIEF DESCRIPTION OF THE DRAWINGS

FIG. 1 is a block diagram of the preferred embodiment Dynamic Process Management System (DPMS) in accordance with the present invention;

FIG. 2 is a block diagram of an example workflow and example dynamic changes to the workflow which could be implemented in the DPMS shown in FIG. 1; and

FIG. 3 is a flowchart of a method of operation of the DPMS shown in FIG. 1 in accordance with the present invention.

### DETAILED DESCRIPTION OF THE INVENTION

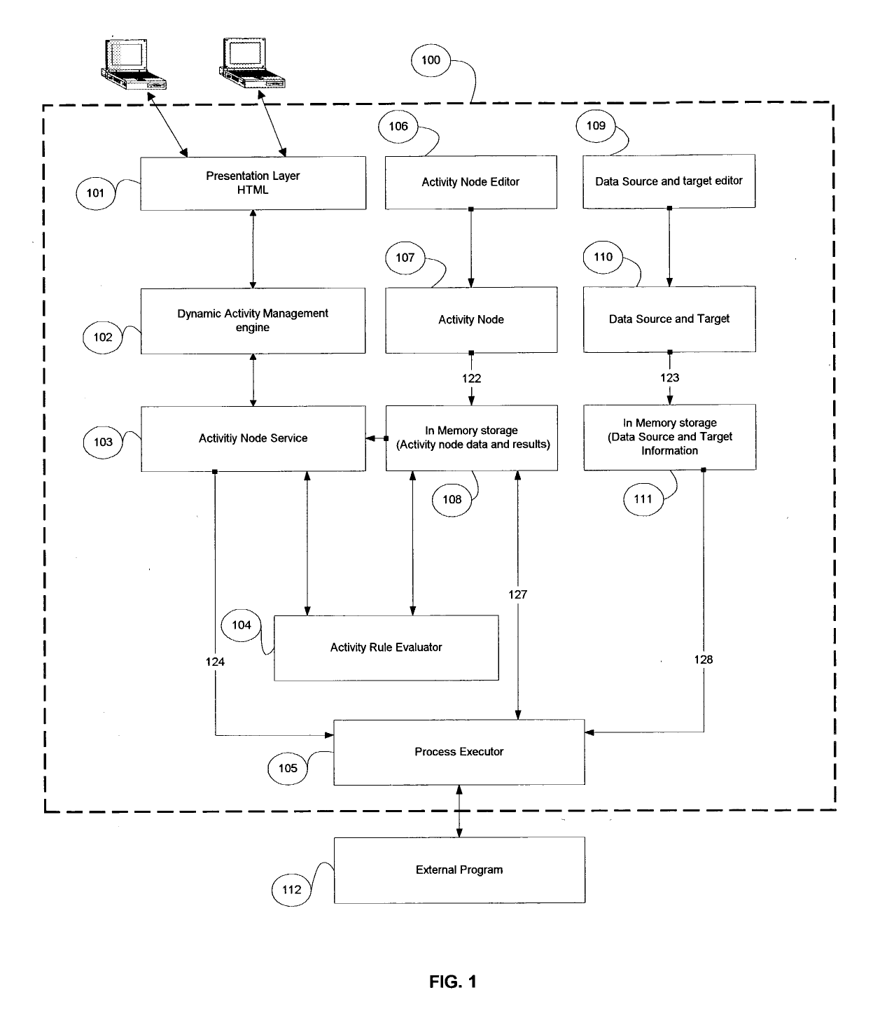

In the following description of the exemplary embodiment, reference is made to the accompanying drawings which form a part hereof, and in which is shown by way of illustration the specific embodiment in which the invention may be practiced. It is to be understood that other embodiments may be utilized as structural changes may be made without departing from the scope of the present invention. Referring now to FIG. 1, a block diagram of the preferred embodiment DPMS system 100 in accordance with the present invention is shown.

The Dynamic Process Management System (DPMS) 100 is a thin client/server web-based product for developing, executing, and managing automated process paths in a distributed computer system consisting of multiple software components on multiple computers running as a single system. The computers in a distributed system can be physically close together and connected by a local network, or they can be geographically distant and connected by a wide area network. A distributed computer system can comprise any number of possible configurations—mainframes, personal computers, workstations, minicomputers, and so forth. The goal of distributed computing is to make such a network act as a single computer.

To understand how the DPMS system 100 automates workplace procedures intelligently and with automatic iterative updates, imagine that your company has hired a firm, ProcessRUs, to manage your work routing procedures. ProcessRUs supplies couriers who are supplied with a set of default office procedures, both formal and informal. The procedures are presented in a process map format, which is a graphical representation of the workflow as defined by the business process owner. However, these couriers are also instructed to depart from the default office procedures if, at any time during the process, the couriers receive new instructions either because the business process owner changes the business process or because of new information generated as part of the workflow process. When necessary, the couriers can also generate their own next set of instructions, based on new introduced rules and environment.

ProcessRUs can provide an unlimited number of these smart couriers to follow these process maps and to adapt to changes as new instructions are received.

Your company is a law firm providing services to numerous companies with different services. Your company wants to hire ProcessRUs to manage your work routing procedure, but you require ProcessRUs to support your customization of the core process map to your business logic. You further require ProcessRUs to quickly modify the core process maps to adapt new economy changes or provide new services for your new expansion. ProcessRUs also provides customization in addition to the core process maps to numerous other law firms who are also its clients.

An example of where your law firm's business logic share certain core features with your competitors but may require different customization is found in the initial client intake process. A core set of features common to all law firms may include such features as reference check, credit check, internal resource checks and conflict checks. Firms will differ as to their procedures. Your law firm may have preferred third party service providers for services such as credit checking or reference checks. Other law firms may handle such steps internally.

Other required features will vary from firm to firm. For example, one firm may centralize all new client decisions to a Managing Partner or New Client Committee for decisions based on the data generated as a result of the procedural checks. Others may prefer that all clients meeting a predetermined set of criteria be immediately assigned to the appropriate department or lawyers for services, with only borderline cases referred to Managing Partner or New Client Committee for final decision.

When operating in a law firm processing cycle, ProcessRUs directs its smart couriers to route the workflow through a default process map as set up by the client law firm or by ProcessRUs. However, the smart couriers are also directed to stop at predetermined steps and check for new or different instructions and verifications based on your local rules, and to depart from the default process maps in accordance with the new or different instructions. The owners of the business solution sets also may wish to base their next processing steps depending on the information generated or processed by the smart couriers; in that case, the smart couriers route the required information to the right department, and receive their next set of instructions locally, based dynamically on the results of the last processing steps.

ProcessRUs allows your law firm to change business process on the fly, or to add new services or features, or to change outside third party service providers, all without the necessity of changing the default process map or the business logic. In addition, every departure from the process map is captured as a different version, and the business process owner has the option of designating at any time or automatically a different version as the default process.

Customized procedures for one customer that are not invasive to other customers is simple because the smart couriers of ProcessRUs can easily depart from the default process map. Instead of following blindly the predefined process map, they can generate locally the next set of instructions based the result from previous tasks and customer profile.

Software overhead and footprint are minimal because the smart couriers follow the default process maps and reevaluate the routing only if it detects changes locally. The smart couriers concentrate on routing work efficiently and dynamically, with your requested customization in business logic, and any changes and updates to the business logic, allowing your business to grow and your employees to focus on processing work, and not the routing or business flow. This also empowers the business process owner to make rapid changes to the business processes or expand to more complex business processes.

The Dynamic Process Management System (DPMS) 100 is an electronic ProcessRUs. It is an application coordinator, and it generates and governs the flow of work between applications external or internal and electronic data file so that they can work together logically and harmoniously. The DPMS's main function is to guarantee that data follows the logical processing steps customized for service organizations, whether it is a predetermined sequence or it has been generated locally on the fly.

The DPMS connects information-processing centers within an enterprise-wide e-business processes which can combine multiple applications and technologies (such as PDAs and fax), by routing and executing work along a dynamic process path initially defined by the business process owner, but updateable iteratively and by the business process owner at will. Images, data, objects, messages and any combination of these are all works which can be routed, generated and processed by the DPMS.

The DPMS system 100 is preferably a dynamic rule-based routing product. It offers the users the ability to dynamically redirect the routing by allowing the couriers to receive new instructions locally. The DPMS keeps track of external information, results of other activities and external means of execution, or access such information locally during its routing process, but does not build in or carry such information, results or execution means within its routing process, thus minimizing its overhead and software footprint. The DPMS system 100 also preferably is a dynamic rule-based business process execution. Instead of hard coding the business process in the rules and the routing product (perhaps using a large number of “IF” statement), the DPMS system 100 offers the ability to generate business commands by executing client specific policy rules and by using client specific data. The command is then executed by specified external applications.

The DPMS system 100 couriers travel between nodes (“activities”) of a connected graph (“map”) which are changed dynamically as new instructions are received locally or generated based on last results, via tags labeled “NextActivities.”

The DPMS system 100, via a user interface (GUI), allows the business process owner to specify i) the command execution result of the previous activity node to compute the command and ii) the command execution result of current node to compute the next activity to be reached., using a language of conditional expression composed of variable, constants, and operators.

Such dynamic rule-based systems are very flexible, extensible and very easy to adapt with the new environment, because values of variables in rules can be readily changes; new rules can be added, and the rules themselves are instantly modifiable to adapt to new changes.

The present invention DPMS system 100 is also a self-learning iterative process management system, with versioning capabilities. If the DPMS does not detect any changes in instructions, it will follow the default process; if there are changes, the system records the changes as a new version, and can be instructed to adopt the new version as the new default process, or a one-time application.

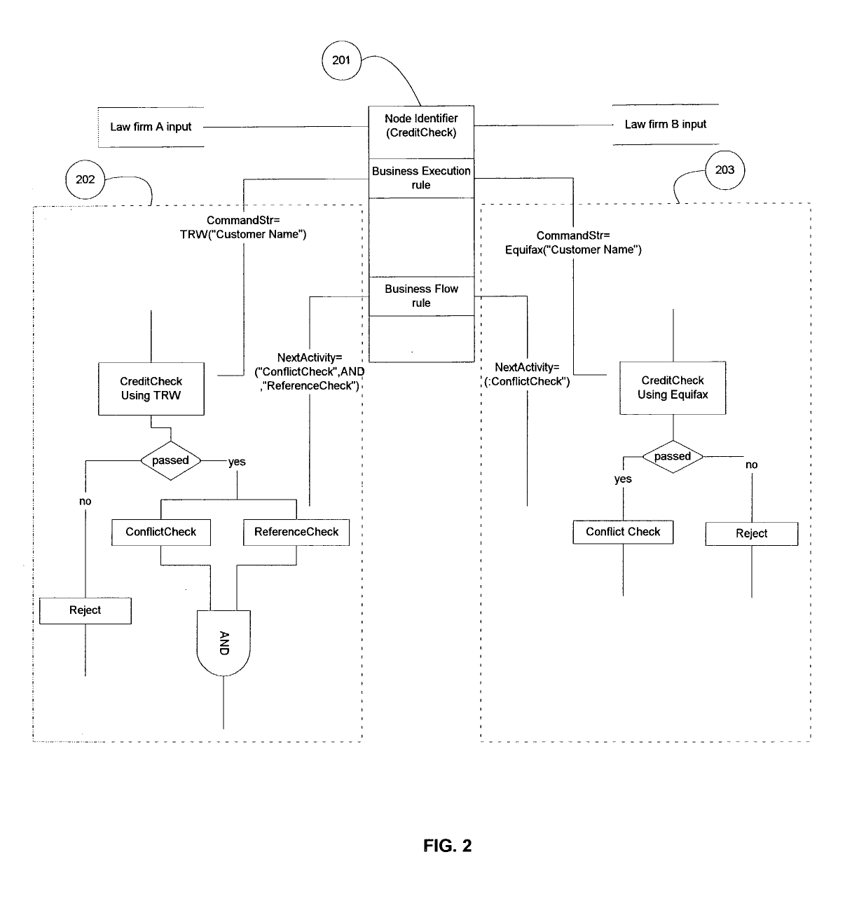

In FIG. 2, the dynamic activity node 201 is specified for the DPMS to perform credit check as part of a generic new client intake system for law firms. Law firm A 202 prefers to use outside service provider TRW to implement the conflict check, and law firm B prefers to use outside service provider Equifax. The core solution 201 remains the same in both cases; however, the DPMS implements two different commands at the appropriate step. For law firm A, the DPMS generates Command=TRW(“customer name”), and for law firm B, the DPMS generates Command=Equifax(“customer name”) and if the credit check is passed law firm A will perform reference check and conflict check in parallel, while law firm B requires the next step to consist only of the conflict check.

An example dynamic activity node named “CreditCheck” set forth below in Table 1 is activated for both law firm A and law firm B, with instructions to access different data sources which in turn alerts the activity node to implement the different activity flow.

```
TABLE 1
Example Dynamic Activity Node:
1. NodeIdentification: CreditCheck
2. DataSourceIdentification: LawfirmDB
3. DataTargetIdentification: Lawfirm DB
4. Business Execution Rule:
{ Let QueryString = ‘select command from Commandtable
          Where Action = “CreditCheck”’
  Let CommandStr = Query(‘QueryString’)
  Let CommandStr = replace (CommandStr,”customername”,“ABC”)
  Command (CommandStr)}
5. DefaultCommand: None
6. BusinessFlowRule:
{ If CommandResult (“CreditCheck”)!= ‘Error’
  Let QueryString = ‘select NextActivity from NextActivityTable
            Where CurrentNode = ‘CreditCheck’
  Let NextActivityStr = Query(QueryString)
  NextActivity(NextActivityStr)
  Else
  NextActivity(“RejectCustomer”)}
7. DefaultNextActivity: None
```

Command tables for law firm A and law firm B (Tables 1.A and 1.B below) differ and may be maintained separately by law firm A and law firm B for action “CreditCheck”

TABLE 1.A
Example Command Table for Law Firm A:

| Action | Command |
|---|---|
| CreditCheck | TRW(“customername”) |

TABLE 1.B
Example Command Table for Law Firm B:

| Action | Command |
|---|---|
| CreditCheck | XYZ(“customername”) |

Next Activity tables for law firm A and law firm B (Tables 1.C and 1.D below) also differ and may be maintained separately by law firm A and law firm B for action “CreditCheck”:

TABLE 1.C
Example Next Activity Table for Law Firm A

| CurrentActivity | NextActivity |
|---|---|
| CreditCheck | ReferenceCheck AND |
| | ConflictCheck |

TABLE 1.D
Example Next Activity Table for Law Firm B

| CurrentActivity | NextActivity |
|---|---|
| CreditCheck | ConflictCheck |

If a law firm wants to use other credit check services, the business solution process owner can change the command “on the fly” to adapt with the new credit check service without interrupting the other law firms which are sharing the same core solution simply by changing the command table for the specific law firm

Dynamic activity nodes can be generated and maintained differently for different business solutions owners with respect to each specific step in the dynamic workflow. Law Firm A, for example, requires ReferenceCheck and Conflict Check after CreditCheck has been completed. Law Firm B requires only ConflictCheck.

The creation, editing, and linkage between the dynamic activity nodes are enabled by the use of the following software modules or similar construct:

1) Activity Node Editor 106

2) Activity Node(s) 107

3) DataSource and Target Editor 109

4) DataSource(s) and Target(s) 110

5) Activity Node Loader 122

6) DataSource and Target Loader 123

7) Dynamic Activity Management Engine 102

8) Activity Node Service 103

9) Activity Rule Evaluator 104

10) Process Executor 105

A business solution process owner uses the Activity Node Editor 106 to create a new Activity Node 107. Via Activity Node Loader 122, the new node structure and data from the Activity Nodes 107 are loaded into InMemory Storage (Activity Node Data and Results) 108, per request from the presentation layer 101 as relayed through the Activity Node Service 103. The Dynamic Activity Management Engine 102 sends the Activity Node Identification to the Activity Node Service 103 to carry out the execution dynamically based on the business rule within the Activity Node and to determine which Activity Node to be processed next depend on the business flow rules within the Activity Node.

The Activity Node Service 103 fulfills its functions as set out below.

1. Carry out the process execution

The Activity Node Service 103 checks whether the Activity Node currently being processed has a defined business execution rule. If yes, the Activity Node service sends the rule to Activity Rule Evaluator 104 via the Business Rule Interface 125 to interpret the activity business rule defined for this activity and generate the dynamic command string (i.e., dynamic task). The command string will be stored into In Memory Storage (Activity Data and Results) 108 as a part of the Activity Node labeled as command string. The Activity Rule Evaluator 104 returns the evaluation result to the Activity Node Service 103 via the Business Rule Interface 125. The Activity Node Service 103 reads the command string from In Memory Storage (Activity Data and Results) 108 and sends the command to the Process Executor 105 via executor command programming interface 124. The Process Executor 105 executes the command and stores the result back into the In Memory Storage (Activity Data and Results) 108 via process application interface 127. Data Source and Target information are also available to the Process Executor 105 via process application interface 128 to access data source and target information stored the InMemory Storage (DataSource and Target) 111.

2. Determine which Activity Node to be processed next.

The Activity Node Service 103 checks whether the Activity Node currently being processed has a defined business flow rule. If yes, the Activity Rule Evaluator 104 interprets the business flow rule to generate a “NextActivity” string and store this string as a part of the Activity Node labeled as NextActivity into the In Memory Storage (Activity Data and Results) 108. The Activity Node Service 103 reads the identification of the next Activity Node and sends the identification and the command to the Dynamic Activity Management Engine 102. The next activity string may contain more than one node identities, in the following syntax: Nodeldentity <op> NodeIdentity <op> NodeIdentity, where the conjunction <op> can be set to be AND or OR, with AND requiring all identified next activities to be completed, and OR requiring only either of the next activities to be completed.

Each activity node is created, edited and maintained separately. During its operations, the DPMS 100 supports direct access to the Dynamic Activity Management Engine 102, the In Memory Storage (Activity Data and Results) 108 and to the In Memory Storage (Data Source and Target) 111. Therefore, the business process solution owner can test each activity node or rule or groups of activity nodes or rules separately by activating each Activity Node via Dynamic Activity Management Engine 102, verifying the results by examine the InMemory Storage (Activity Data and Results) 108 and modify activity node and rules using Activity Node Editor 106 and Activity Node Loader 122.

The Activity Nodes 107 and Data Sources and Targets 110 preferably are stored in a database or in an ASCII file applying markup language such as XML. The Activity Node Holder 107 and Data Source and Target Holder 110 may be controlled by versioning system, which enables the business process solution owner to specify the optimal version for the specific business solution.

The Dynamic Activity Management Engine 102 can be programmed to detect any changes in the environment. If the Dynamic Activity Management Engine 102 detects any changes, the Dynamic Activity Management Engine 102 instructs the Activity Node Service 103 to generate a new command or a new next node identification command. Otherwise, the routing and execution are accomplished with the existing default command and default next node identification command.

The Activity Nodes 107 and Data Sources and Targets 110 can be loaded into the In Memory Storage (Activity Data and Results) 108 and In Memory Storage (Data Source and Target) 111 and accessed directly using any commercial software package available, such as packages developed by Oracle, Microsoft, IBM, or SUN Microsystems.

The Presentation Layer 101 may be a part of the application with embedded “dynamic process management system” as one of their component. With this extra feature the business logic and input/output interfaces are decouple from the application that supports the customization of multiple user group. This decoupling also allows the changes made to one individual user or group not to affect or shut down the operations of any other users or user groups.

For each activity node, when the command is executed, the results can be a string, a record sets or both, and the results are stored in an addressable memory In Memory Storage (Activity Data and Results) 108 and associated with the processing activity via the Process Application Interface 127. These functions can be implemented using commercial software packages supporting XML technology, such as record set provided by Microsoft, IBM or in memory operated database provided by TimesTen. It will be appreciated by those skilled in the art that other forms of record set, in memory table, nested tables, nested record set for hierarchical data structure can be used without departing from the scope and spirit of the present invention.

Like other rules language currently available in the marketplace or previously described in previous inventions, the rule language of the present invention share the common characteristic of conditional statement “if-then-else”, repeat statement “repeat-until”, assign statement “let A=B”, but the main focus of the rules language of the present invention is to build a string, i.e., “command string” and “next activity string,” by evaluating data accordingly with the associated business rules and using information of other activity nodes and using the results of previous execution. The following Table 2 lists some examples of the functions used to access information and desired results of the activity nodes in this preferred embodiment rule language. It will be appreciated by those skilled in the art that other functions and symbols could be used without departing from the scope and spirit of the present invention.

TABLE 2

| Group | Name | Syntax | Description |
|---|---|---|---|
| String | Concat | Str1 = Concat(str2 + str3 + . . . ) | Concatenate |
| Manipulation | | | strings together |
| | GetWordAt | Word = | Get a word from |
| | | GetWordAt(string, position, “delimiter”) | a string by given |
| | | | the position word |
| | | | delimiters |
| | Split | A[] = Split(string, “delimiter”) | Split a string |
| | | | into an array of |
| | | | words |
| Read | NodeDataAt | Data = NodeDataAt(“NodeName”, | Retrieve the |
| InMemory | | “Attribute location”) | attribute data, by |
| Storage | | | giving the node |
| | | | name and the |
| | | | location |
| | NodeDataWhere | Data = | Retrieve the |
| | | NodeDataWhere(“NodeName, ”condition”) | attribute data by |
| | | | given node name |
| | | | and the |
| | | | condition |
| Access the | GetRecordset | Data[] = | Retrieve an |
| results of | | GetRecordSet(“NodeName”, “condition”) | array of records |
| command | | | from the record |
| execution | | | set associated |
| | | | with the given |
| | | | activity node |
| | | | name |
| | CommandResult | Result = | Return the result |
| | | CommandResult(“NodeName”) | of the command |
| | | | associated with |
| | | | the given activity |
| | | | node name |
| Database | Query | String = Query(“Database”, “select | Return one |
| function | | statement”) | record matching |
| | | | the select |
| | | | statement |
| | QueryArray | Array[] = Query(“Database”, “select | Return multiple |
| | | statement”) | record matching |
| | | | the select |
| | | | statement |
| String return | Command | Command(“Command String”) | Update the |
| from the rule | | | value of the |
| evaluator | | | Activity Node's |
| | | | default command |
| | NextActivity | NextActivity(“Next activity String) | Update the |
| | | | value of the |
| | | | Activity Node's |
| | | | NextActivity. |

A “command string” is a predefined structure and a syntax that is agreed to and used by the Process Executor 105 to invoke external application or applications 112 registered in the distributed network. The preferred command string syntax is a list of literal string enclosed by double code or using XML. It will be appreciated by those skilled in the art that other syntax could be used without departing from the scope and spirit of the present invention.

The preferred embodiment syntax of “command string” are enclosed by:

(“prog1”, “arg1”, . . . , “argn”)

or if XML syntax is applied:

(<program>prog1</program>
<arglist> <arg> arg1 </arg>

<arg> arg2 </arg>

<arg> argn</arg>

</arglist>)

The preferred syntax of the “Next Activity string” is a list of string enclosed by double quote or using XML to describe the node identification. It will be appreciated by those skilled in the art that other syntax or additional attribute like attribute to set the limit for minimum or maximum execution time of this activity node could be used without departing from the scope and spirit of the present invention.

If the “NextActivity string” contains more than one node name connected with logical operator “AND” or “OR”, then all nodes identified in the Next Activity string can be executed in parallel. The next activity string may contain more than one node identities, in the following syntax: NodeIdentity <op> NodeIdentity <op> NodeIdentity, where the conjunction <op> can be set to be AND or OR, with AND requiring all identified next activities to be completed, and OR requiring only either of the next activities to be completed.

The preferred embodiment syntax of “Next Node string” are enclosed by either Double code:

(“Nodename1”,<op>,“Nodename2”, . . . )

or if XML syntax is applied:

(<NextActivity

<Node>
<name> Node1 </name>
<op> AND <op>

</Node>

<Node>

<name> Node2 <./name>
<op></op>

</Node>
</NextNode>)

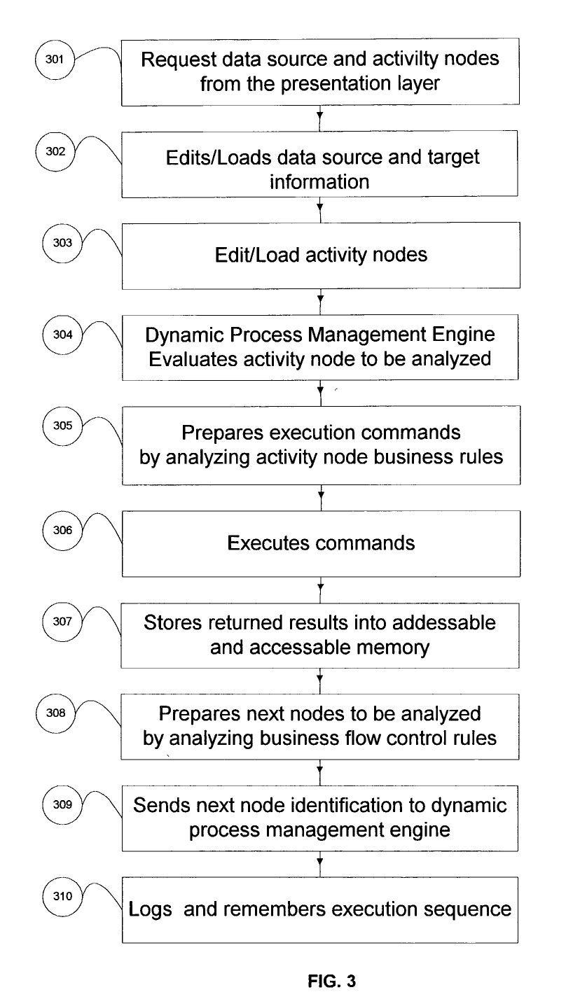

The preferred embodiment of the present invention may also be described in reference to computer-implemented steps 301-310 of the DPMS 100 as shown in the flow diagram of FIG. 3. First, the DPMS 100 requests data source and activity nodes from the presentation layer 301. Then, the DPMS 100 edits and loads data source and target information 302, and edits and loads the activity nodes 303. Each activity node may have two types of rules; the business execution rule and the flow control rules. Based on business execution rule, the DPMS 100 determines the activity node(s) to be analyzed 304 through the Dynamic Process Management Engine 102. The DPMS 100 then prepares the execution command 305 dynamically and sends the execution command to external execution programs 306. After execution has been completed, the external programs return and store the returned result into addressable memory section and make it accessible by the rule evaluator 307. The DPMS 100 then prepares the next activity node to be analyzed 308 and sends next node identification to the Dynamic Process Management Engine 309 dynamically in accordance with the associated business flow rules. The rules used in the DPMS 100 are derived from a rule language which have a list function described in Table 2 to access activity node data, execution results and information about data source and target on the fly to prepare dynamic execution command string and dynamic execution sequence.

When the DPMS 100 sends the execution command to external program 306, the DPMS may alternatively reuse the execution commands generated in previous execution of the rules if no change is detected.

The dynamic execution sequence are logged and remembered in step 310 versionally for the tracking the performance of each activity, as well as for later retrieval, reuse, process optimization and fine turning.

The foregoing description of the exemplary embodiment of the invention has been presented for the purposes of illustration and description. It is not intended to be exhaustive or to limit the invention to the precise form disclosed. Many modifications and variations are possible in light of above teaching. It is intended that the scope of the invention be limited not with this detailed description, but rather by the claims appended hereto. It will be appreciated by those skilled in the art that this system can be configured utilize modern application server, XML or NET technology provided by software vendor like IBM, BEA, Microsoft, etc. and it can be applied in a web based application hosting services. without departing from the scope and spirit of the present invention.

What is claimed is:

1. A computer implemented method for dynamically activating process activities and generating work process execution sequencer, comprising the steps of:
specifying at least one data source containing initial data;
specifying at least one data target for receipt of result data;
constructing a plurality of activity nodes with coupling means to the data source and data target and containing at least one set of business execution rule and one set of business flow rule;
constructing a rule evaluator according to pre-determined sets of rules;
specifying at least one activity node.
generating activity command through the rule evaluator according to pre-determined business execution rule contained in said activity node automatically by software without human intervention;
storing command output in an addressable memory area accessible to rule evaluator;
generating next activity node identification through the rule evaluator according to the business flow rules contained in said activity node automatically by software without human intervention and return evaluation output as command string; and
returning result data to data target;

2. The computer implemented method of claim 1, where the activity node comprises a data source identification, data target identification, business execution rule, default command, business flow rule, and a default set of next activity;

3. The computer implemented method of claim 1, where the business execution rule within the activity node comprises a conditional statement, an assign statement, a list of functions for accessing the output of previous activity residing in the In Memory Storage (Activity Data and Result) and a list of string manipulation functions for generating commands;

4. The computer implemented method of claim 1, where the rule evaluator pulls data from the In memory storage (data source and target) and generates activity command according to the business execution rule within an activity node automatically by software without human intervention;

5. The computer implemented method of claim 1, where the rule evaluator accesses data from the In memory storage (activity node data and result) and generates next activity identification according to the business flow rule within an activity node automatically by software without human intervention;

6. The computer implemented method of claim 1, where the process executor accesses data from the In Memory Storage (data source and target) and perform command execution step according to the activity command generated by the rule evaluator automatically by software without human intervention;

7. The computer implemented method of claim 1, where the activity node service accesses data from the In Memory Storage (activity node data and result) and perform command execution step according to the next activity command generated by the rule evaluator automatically by software without human intervention;

8. The computer implemented method of claim 1 further comprising the step of accessing data from a first activity node to generate a next activity identification which directs the Activity Node Service to specify a second activity node for the rule evaluator to generate commands automatically by software without human intervention;

9. The computer implemented method of claim 1 further comprising the step of analyzing a plurality of activity nodes in parallel through a plurality of the business solution sequences;

10. A computer-readable medium having stored thereon instructions in human readable format for causing a computer to execute dynamic work flow process application comprising:
at least one data source identification with coupling means to access data source wherein resides the data needed to generate the activity node command;
at least one data source identification with coupling means to access data source wherein resides data needed to generate next activity identification to be analyzed;
at least one data target identification with coupling means to deliver data results from the operation of the workflow process;
a plurality of activity nodes;
at least one addressable memory identification with coupling means to access initial data;
at least one addressable memory identification with coupling means to deliver and coupling means to access data generated from the operation of the workflow process;
at least one set of business execution instruction rule set for generating command for each activity node automatically by software without human intervention and having a default rule set;
at least one set of business flow instruction rule set for generating the identification of the activity node to be analyzed automatically by software without human intervention and having a default rule set; and
one rule evaluator constructed according to pre-determined set of rules;

11. The computer-readable medium of claim 10 further comprising at least one data source and data target loader component to implement the loading of activity node data into memory for each activity node automatically by software without human intervention;

12. The computer readable medium of claim 10 further comprising of a dynamic activity management engine component, activity node service component, and activity rule evaluator;

13. The computer readable medium of claim 10 where the activity rule evaluator and the business execution rule component generate the activity node command execution automatically by software without human intervention;

14. The computer readable medium of claim 10 where the activity rule evaluator and the business execution rule component generate the next activity node command automatically by software without human intervention.
